(19) United States
(12) Patent Application Publication
(10) Pub. No.: US 2010/0175038 A1
(43) Pub. Date: Jul. 8, 2010

(54) Techniques for Implementing an Engineering Change Order in an Integrated Circuit Design

(75) Inventors: Jeremy T. Hopkins, Round Rock, TX (US); Thomas E. Rosser, Austin, TX (US)

Correspondence Address: DILLON & YUDELL LLP, 8911 N. CAPITAL OF TEXAS HWY.,, SUITE 2110, AUSTIN, TX, 78759, US

(73) Assignee: INTERNATIONL BUISNESS MACHINES CORPORATION, Armonk, NY (US)

(21) Appl. No.: 12/349,289

(22) Filed: Jan. 6, 2009

(51) Int. Cl. G06F 17/50

(52) U.S. Cl. 716/12

(57) ABSTRACT

A technique for implementing an engineering change order (ECO) includes comparing a first hardware description language (HDL) design with a second HDL design. In this case, the second HDL design corresponds to the first HDL design with at least one implemented ECO. The technique identifies differences in latch points, primary inputs, and primary outputs between the first and second HDL designs. The second HDL design is converted to a non-optimized netlist. Logical cones (cones of logic) that feed the latch points, the primary inputs, and the primary outputs are extracted from the non-optimized netlist. Based on the extracted logical cones and the non-optimized netlist, a physical implementation of the second HDL design is synthesized.

### BACKGROUND

1. Field

This disclosure relates generally to an integrated circuit design and, more specifically, to techniques for implementing an engineering change order in an integrated circuit design.

2. Related Art

Traditionally, circuit designers have employed circuit design and synthesis software applications (circuit design tools) to design integrated circuits (chips). Typically, circuit designers specify logical computation based on available inputs, desired outputs, and performance parameters within which a chip is required to perform. A completed chip design is defined by a set of logic components (which are capable of performing various logical functions, such as a single logical operation, for example, an AND function, an OR function, a NOT function, a NAND function, a NOR function, or an XOR function, as well as combinations of logical functions) provided in a netlist. A netlist includes a collection of components (e.g., logic components and other circuit components, such as resistors and capacitors) and an organization of the components that result from a circuit design. A logic circuit that is configured to perform one or more logical operations is commonly referred to as a gate. A gate array is a set of gates arranged in a particular manner.

When an original circuit design is complete, a circuit designer usually tests the circuit design for compliance with design parameters (specifications). For example, design specifications may include timing, gate delay, and slew rate. An original circuit design may contain errors, such as faulty logic, or fail to meet design parameters. For example, a specification may call for processor operation at 2 GHz, when a designed processor only operates correctly at 1.8 GHz. As another example, a logic component within a circuit may have a longer delay than permitted, causing a next cone of logic (i.e., logic components that are grouped together to perform a part of a logical computation) that accepts output from the logic component (as input) to produce an incorrect result.

Typically, circuit design code, which is written in a programming language (e.g., VHDL or Verilog), is used to produce sets of photolithographs, which are photographic images of all layers (i.e., semiconductor and metal layers) in a circuit design. One set of photolithographs that is used to fabricate a chip is usually referred to as a release interface tape A (RIT-A) design, which includes images of non-metallic layers used in forming a chip. Another set of photolithographs that is used to fabricate a chip is usually referred to as a release interface tape B (RIT-B) design, which includes a set of photolithographs that contain images of metallic layers of the chip that connect various circuit components. The RIT-A and RIT-B designs are used together to fabricate a designed circuit.

Occasionally, an error in a circuit design may escape detection until after an original circuit design is completed. When an error in a circuit design has occurred, a circuit designer has had to identify the error, design a logic circuit that corrects the error, and modify the original circuit design to include the logic circuit that corrects the error. The circuit designer has then tested the modified circuit design to ensure the modified circuit design actually corrects the error and meets design parameters. Unfortunately, modification of photolithographs associated with an RIT-A design is generally time-consuming and relatively expensive. As such, circuit designers have generally avoided making modifications to photolithographs included in an RIT-A design to correct an error in an original circuit design. As compared to modifying photolithographs in a RIT-A design, modifying photolithographs in an RIT-B design has generally provided a relatively inexpensive way of making modifications to a circuit design.

In an original circuit design of a chip, circuit designers have typically provided filler cells, which are areas on a chip that includes gates that do not have an assigned function in an original circuit design. That is, the filler cells are not connected in an original RIT-B design. In this manner, when an error occurs, a circuit designer may connect one or more filler cells (or portions of one or more filler cells) in a modified RIT-B design to connect logic components required in a modified circuit design. In general, circuit design tools have been used to produce modified circuit designs, in the form of an original RIT-A design and a modified RIT-B design, based on code that describes the modified circuit design.

In order to implement an engineering change order (ECO), a circuit designer has traditionally identified nets in a logical cone affected by the ECO and nets for implementing new logic associated with the ECO. Unfortunately, as simple functions may be combined into more complex functions and/or more complex functions may be divided into multiple simple functions during optimization, nets that exist in a hardware description language (HDL) code may not exist in an optimized netlist. In this case, the correct identification of nodes to implement an ECO can be complex and error prone.

### SUMMARY

According to one aspect of the present disclosure, a technique for implementing an engineering change order (ECO) includes comparing a first hardware description language (HDL) design with a second HDL design. In this case, the second HDL design corresponds to the first HDL design with at least one implemented ECO. The technique identifies differences in latch points, primary inputs, and primary outputs between the first and second HDL designs. The second HDL design is converted to a non-optimized netlist. Logical cones (cones of logic) that feed the latch points, the primary inputs, and the primary outputs are extracted from the non-optimized netlist. Based on the extracted logical cones and the non-optimized netlist, a physical implementation of the second HDL design is synthesized.

### BRIEF DESCRIPTION OF THE DRAWINGS

The present invention is illustrated by way of example and is not intended to be limited by the accompanying figures, in which like references indicate similar elements. Elements in the figures are illustrated for simplicity and clarity and have not necessarily been drawn to scale.

FIG. 1 is a diagram of an example computer system that may be employed to execute a circuit design tool.

FIG. 2 is a flowchart of an example process for implementing an engineering change order (ECO) in an integrated circuit design, according to one embodiment of the present disclosure.

### DETAILED DESCRIPTION

As will be appreciated by one of ordinary skill in the art, the present invention may be embodied as a method, system, or computer program product. Accordingly, the present invention may take the form of an entirely hardware embodiment, an entirely software embodiment (including firmware, resident software, microcode, etc.) or an embodiment combining software and hardware aspects that may all generally be referred to herein as a “circuit,” “module,” or “system.” Furthermore, the present invention may take the form of a computer program product on a computer-usable storage medium having computer-usable program code embodied in the medium.

Any suitable computer-usable or computer-readable storage medium may be utilized. The computer-usable or computer-readable storage medium may be, for example, but is not limited to an electronic, magnetic, optical, electromagnetic, infrared, or semiconductor system, apparatus, or device. More specific examples (a non-exhaustive list) of the computer-readable medium storage includes the following: a portable computer diskette, a hard disk, a random access memory (RAM), a read-only memory (ROM), an erasable programmable read-only memory (EPROM) or Flash memory, a portable compact disc read-only memory (CD-ROM), an optical storage device, or a magnetic storage device. Note that the computer-usable or computer-readable storage medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this disclosure, a computer-usable or computer-readable storage medium may be any medium that can contain or store the program for use by or in connection with an instruction execution system, apparatus, or device.

Computer program code for carrying out operations of the present invention may be written in an object oriented programming language, such as Java, Smalltalk, C++, etc. However, the computer program code for carrying out operations of the present invention may also be written in conventional procedural programming languages, such as the “C” programming language or similar programming languages.

The present invention is described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the flowchart and/or block diagram block or blocks.

The computer program instructions may also be loaded onto a computer or other programmable data processing apparatus to cause a series of operations to be performed on the computer or other programmable apparatus to produce a computer implemented process such that the instructions which execute on the computer or other programmable apparatus implement the functions/acts specified in the flowchart and/or block diagram block or blocks. As used herein, the term “coupled” includes both a direct electrical connection between blocks or components and an indirect electrical connection between blocks or components achieved using one or more intervening blocks or components.

According to various aspects of the present disclosure, techniques are employed to automate and reduce costs associated with implementing an engineering change order (ECO) in an integrated circuit (chip) design. According to the present disclosure, an original circuit design may be automatically corrected based on differences in two HDL designs. According to various embodiments of the present disclosure, implementation of an ECO includes comparing a first hardware description language (HDL) design with a second HDL design. In this case, the second HDL design corresponds to the first HDL design with at least one implemented ECO. The comparison identifies differences in latch points, primary inputs, and primary outputs between the first and second HDL designs. The second HDL design is then converted to a non-optimized netlist. Logical cones (cones of logic) that feed the latch points, the primary inputs, and the primary outputs are then extracted from the non-optimized netlist. Based on the extracted logical cones and the non-optimized netlist, a physical implementation of the second HDL design is synthesized.

For example, an original HDL design may be compared with a new HDL design (that incorporates an ECO to the original HDL design) with various commercially available comparison tools, e.g., Encounter Conformal™ by Cadence or Verity™ by International Business Machines Corporation. In general, a part of a circuit design reflected in an RIT-A design includes a netlist that defines a layout of circuit components in non-metallic layers of a chip and filler cells. Typically, an RIT-A design includes information about specific points in a circuit design called hooks (or anchor points). Hooks are locations in the circuit design where certain signals are available, and certain components are accessible. For example, a hook may be a point of connection in a circuit where a specific output signal of a logic computation is available. When a subsequent logic computation has an error in an original circuit design, a hook can serve as an input to a replacement logic circuit that corrects the error.

A part of the circuit design reflected in an RIT-B design includes a netlist that defines a layout of circuit components in metallic layers of a chip. An RIT-A and RIT-B design may also include information about gates that were originally present in the design but for one reason or another were disconnected. For example, a circuit designer may disconnect parts of a circuit for a variety of reasons, such as redesign, eliminated functionality, and/or a changed specification. A disconnected part may include components, such as gates, that are no longer used in the circuit. Some of these gates may have their inputs and outputs situated in a manner that makes the reuse of the gates for a later modification convenient. A component situated in this manner in a disconnected part of a design is referred to herein as a ‘spare’.

The netlist for the RIT-B design includes information about spares that can be formed into logic circuits. In various embodiments, a circuit design tool is configured to accept two HDLs, one of which implements an ECO, and compare the two HDLs. The comparison identifies differences in latch points, primary inputs, and primary outputs between the first and second HDL designs. The second HDL design is then converted to a non-optimized netlist. Logical cones (cones of logic) that feed the latch points, the primary inputs, and the primary outputs are then extracted from the non-optimized netlist. Based on the extracted logical cones and the non-optimized netlist, a physical implementation of the second HDL design is then synthesized using a synthesis tool, e.g., Encounter™ by Cadence. In general, a synthesis tool should be configured to hide logic that should not be modified (i.e., in order to prevent modification to logic that should not be modified). In this manner, the synthesis tool may use metallic layer information and information about the spares and filler cells to synthesize gates needed for implementing an ECO.

A tool may reuse one or more spares or portions of the one or more spares (disconnected components, gates, and other disconnected parts of the circuit) to implement an ECO. For example, a tool may determine that a NAND gate is needed in the synthesis of the modified circuit design. For example, a disconnected NAND gate available in the RIT-A design can be connected in the modified circuit design. Alternatively, when a spare is not available, a circuit designer can fabricate a NAND gate by converting one or more filler cells into a NAND gate through changes in the metallic layers in the RIT-B design. In either case, the modified logic is stitched (integrated) into an original (or current) circuit design in order to achieve a desired correction in the logic of the overall circuit.

The tool may then be used by the circuit designer to test the modified circuit design to determine any adverse effects of the modification on other parts of the circuit design. A circuit designer may also test the modified circuit design to determine whether the overall modified characteristics of the modified circuit design meet design parameters. Depending on the results of the testing, a circuit designer can make further modifications to ensure compliance with design parameters. The RIT-B photolithographs containing the modified design and the previously available RIT-A photolithographs can then be used to fabricate a chip that meets performance requirements. As generation of photolithographs is manufacturing process specific, a particular nomenclature used in a specific manufacturing process may differ from the nomenclature of RIT-A and RIT-B designs described herein. However, the concept of grouping non-metallic and metallic layers photolithographs is a common practice in the semiconductor industry.

According to one embodiment of the present disclosure, a technique for implementing an engineering change order (ECO) includes comparing a first hardware description language (HDL) design with a second HDL design. In this case, the second HDL design corresponds to the first HDL design with at least one implemented ECO. The technique identifies differences in latch points, primary inputs, and primary outputs between the first and second HDL designs. The second HDL design is converted to a non-optimized netlist. Logical cones (cones of logic) that feed the latch points, the primary inputs, and the primary outputs are extracted from the non-optimized netlist. Based on the extracted logical cones and the non-optimized netlist, a physical implementation of the second HDL design is synthesized.

According to one aspect of the present disclosure, a computer-readable storage medium includes first, second, third, fourth, and fifth code for implementing an engineering change order (ECO). The first code is configured to compare a first hardware description language (HDL) design with a second HDL design. In this case, the second HDL design corresponds to the first HDL design with at least one implemented ECO. The second code is configured to identify differences in latch points, primary inputs, and primary outputs between the first and second HDL designs. The third code is configured to convert the second HDL design to a non-optimized netlist. The fourth code is configured to extract, from the non-optimized netlist, logical cones (cones of logic) that feed the latch points, the primary inputs, and the primary outputs. The fifth code is configured to synthesize, based on the extracted logical cones and the non-optimized netlist, a physical implementation of the second HDL design.

It should be appreciated gates with more than a required number of inputs may be utilized to produce a gate having a desired number of inputs. For example, a two-input NAND gate may be created from a three-input NAND gate by tying an input of the three-input NAND gate to another input of the three-input NAND gate.

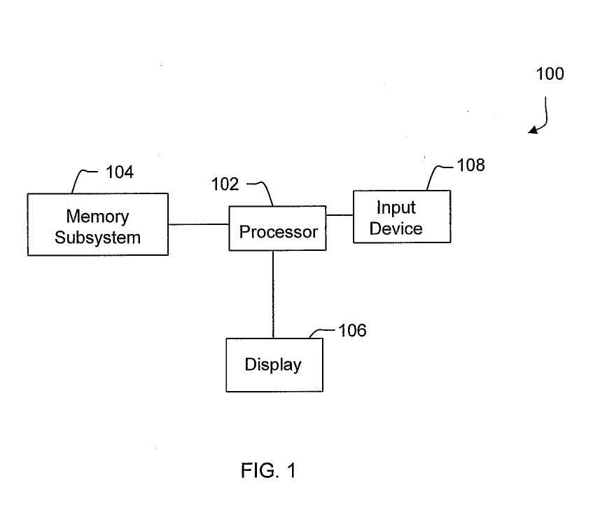

With reference to FIG. 1, an example computer system 100 is illustrated that may be configured to execute a circuit design tool configured to automate the implementation of ECOs according to various embodiments of the present disclosure. The computer system 100 includes a processor 102 that is coupled to a memory subsystem 104, a display 106, and an input device 108. The processor 102 may, for example, be designed to include one or more spares according to the present disclosure. The memory subsystem 104 includes an application appropriate amount of volatile memory (e.g., dynamic random access memory (DRAM)) and non-volatile memory (e.g., read-only memory (ROM)). The display 106 may be, for example, a cathode ray tube (CRT) or a liquid crystal display (LCD). The input device 108 may include, for example, a mouse and a keyboard. The processor 102 may also be coupled to one or more mass storage devices, e.g., a compact disc read-only memory (CD-ROM) drive.

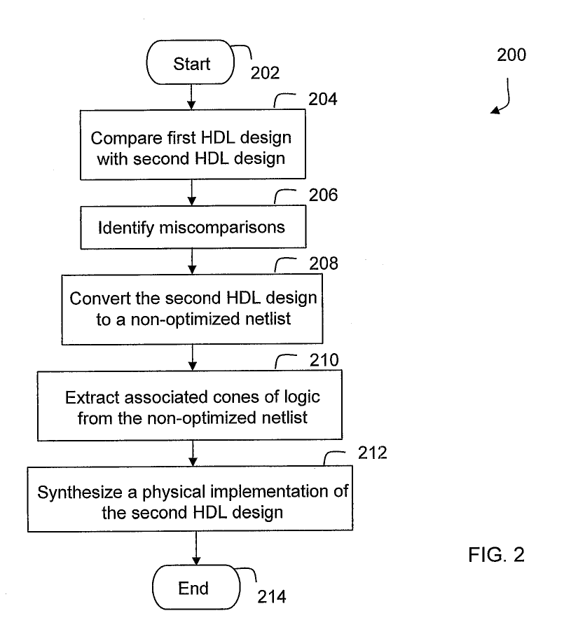

With reference to FIG. 2, an example process 200 for implementing an ECO, according to one or more aspects of the present disclosure, is illustrated. The process 200 may execute, for example, on the computer system 100, which may be a server, a desktop computer, a laptop computer, a workstation, etc. The process 200 is initiated in block 202, at which point control transfers to block 204. In block 204, the process 200 compares a first HDL design with a second HDL design. In this case, the second HDL design corresponds to the first HDL design with at least one implemented ECO. Next, in block 206, differences in latch points, primary inputs, and primary outputs between the first and second HDL designs are identified. Then, in block 208, the second HDL design is converted to a non-optimized netlist. Next, in block 210, logical cones (cones of logic) that feed the latch points, the primary inputs, and the primary outputs are extracted from the non-optimized netlist. Then, in block 212, a physical implementation of the second HDL design is synthesized based on the extracted logical cones and the non-optimized netlist. Following block 212 the process 200 terminates in block 214. Accordingly, techniques have been disclosed herein that generally reduce a turn-around time (TAT) required to implements ECOs in an integrated circuit design. The disclosed techniques also generally reduce the complexity and the number of errors associated with implementing ECOs.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below, if any, are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to preferred embodiments thereof, it will be apparent that modifications and variations are possible without departing from the scope of the invention defined in the appended claims.

What is claimed is:

1. A method of implementing an engineering change order, comprising:
comparing a first hardware description language design with a second hardware description language design, wherein the second hardware description language design corresponds to the first hardware description language design with at least one implemented engineering change order;
identifying differences in latch points, primary inputs, and primary outputs between the first and second hardware description language designs;
converting the second hardware description language design to a non-optimized netlist;
extracting, from the non-optimized netlist, logical cones that feed the latch points, the primary inputs, and the primary outputs; and
synthesizing, based on the extracted logical cones and the non-optimized netlist, a physical implementation of the second hardware description language design.

2. The method of claim 1, wherein the first and second hardware description level designs are Verilog designs.

3. The method of claim 1, wherein the first and second hardware description level designs are VHDL designs.

4. The method of claim 1, wherein the engineering change order is a RIT-A engineering change order.

5. The method of claim 1, wherein the engineering change order is a RIT-B engineering change order.

6. The method of claim 1, wherein the non-optimized netlist is a traceable non-optimized netlist.

7. A computer-readable storage medium, comprising:
first code for comparing a first hardware description language design with a second hardware description language design, wherein the second hardware description language design corresponds to the first hardware description language design with at least one implemented engineering change order;
second code for identifying differences in latch points, primary inputs, and primary outputs between the first and second hardware description language designs;
third code for converting the second hardware description language design to a non-optimized netlist;
fourth code for extracting, from the non-optimized netlist, logical cones that feed the latch points, the primary inputs, and the primary outputs; and
fifth code for synthesizing, based on the extracted logical cones and the non-optimized netlist, a physical implementation of the second hardware description language design.

8. The computer-readable storage medium of claim 7, wherein the first and second hardware description level designs are Verilog designs.

9. The computer-readable storage medium of claim 7, wherein the first and second hardware description level designs are VHDL designs.

10. The computer-readable storage medium of claim 7, wherein the engineering change order is a RIT-A engineering change order.

11. The computer-readable storage medium of claim 7, wherein the engineering change order is a RIT-B engineering change order.

12. The computer-readable storage medium of claim 7, wherein the non-optimized netlist is a traceable non-optimized netlist.
